(19) United States
(12) Patent Application Publication
(10) Pub. No.: US 2003/0197317 A1
(43) Pub. Date: Oct. 23, 2003

(54) Garage door opener vibration isolation kit

(76) Inventors: Paul Meisel, Dublin, OH (US); Bryan S. Boggs, West Jefferson, OH (US)

Correspondence Address: Kathleen K. Bowen, 311 Hillbrook Dr., Cuyahoga Falls, OH, 44223, US

(21) Appl. No.: 10/124,054

(22) Filed: Apr. 17, 2002

(51) Int. Cl. F16F 5/00

(52) U.S. Cl. 267/140.11

(57) ABSTRACT

According to an aspect of the invention there is a garage door opener vibration isolation kit, which isolates the garage door motor from the ceiling, and isolates the drive track from the header, and which comprises a motor isolation kit, and a header isolation kit.

### BACKGROUND

The present invention is in the field of noise and vibration control. The invention is particularly useful for reducing vibration and noise created by operating a garage door opener.

An increasing number of homes being built today have rooms over the garage. These rooms are often used for offices, bedrooms, or entertainment centers. The noise and vibration created by the opener when the garage door goes up or down can be disruptive in these situations. Unfortunately, this is a problem which is often not recognized until the home is built.

Previous inventions have made attempts to reduce the noise created by the opening of the garage door. One such invention is U.S. Pat. No. 5,761,850 by Lhotak et al. Lhotak et al discloses a garage door opener which attempts to reduce noise with a vibration damper which uncouples the electric motor vibrationally from the housing of the head unit. The head unit in Lhotak is connected to the motor mount. Lhotak et al, and other prior art have attempted to reduce the noise from a garage door opening by isolating the motor. This approach ignores the fact that a substantial amount of the vibration and noise produced when a garage door opener is operated is caused by the drive system (usually a drive chain in the drive track).

A method and apparatus is desired which can reduce the noise and vibration transferred to the house when the garage door is opened. Not only is it desirable to reduce the noise from the motor, but the drive track vibration also needs to be addressed. Preferably this apparatus would be in the form of a kit which can be added after construction by the homeowner with a minimum of difficulty.

### SUMMARY OF THE INVENTION

According to an aspect of the invention there is a garage door opener vibration isolation kit, which isolates the garage door motor from the ceiling, and isolates the drive track from the header, and which comprises a motor isolation kit, and a header isolation kit.

### BRIEF DESCRIPTION OF THE DRAWINGS

FIG. 1 is a side view of a garage door opener which has been adapted with a garage door opener vibration isolation kit according to an aspect of the invention.

FIG. 2 is a side view of a portion of an installed motor vibration isolation kit according to an aspect of the invention.

FIG. 3 is an exploded view of an installed motor vibration isolation kit according to an aspect of the invention.

FIG. 4 is a side view of an installed header vibration isolation kit according to an aspect of the invention.

FIG. 5 is an exploded view of an installed header vibration isolation kit according to an aspect of the invention.

### DETAILED DESCRIPTION

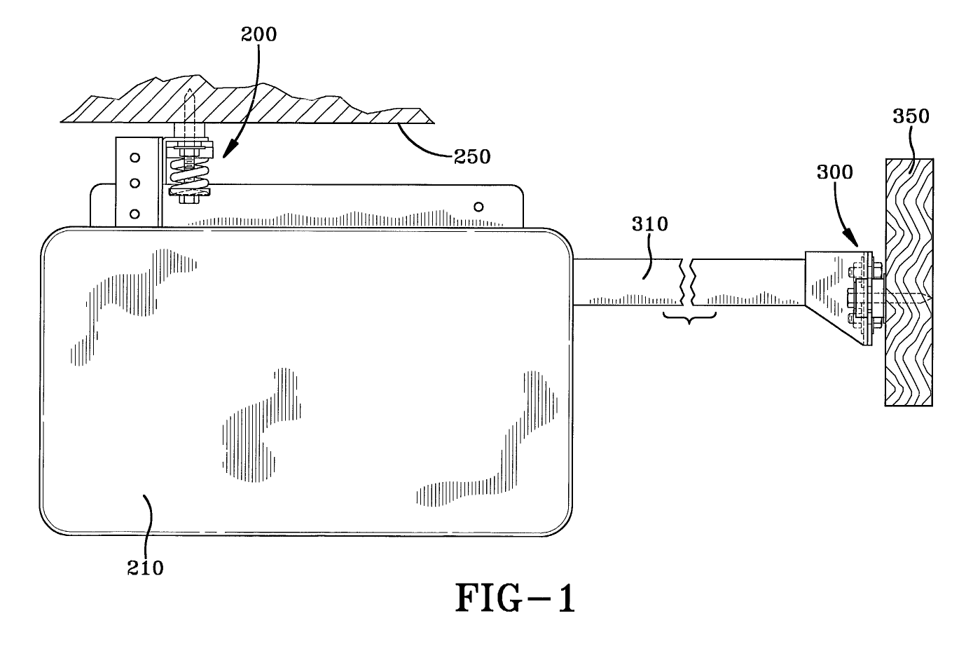

Various aspects of the invention are presented in FIGS. 1-5 which are not drawn to scale and in which like components are numbered alike. Referring now to FIG. 1, according to an aspect of the invention a garage door opener vibration isolation kit 100 to isolate the garage door motor 210 from the ceiling 250, and to isolate the drive track 310 from the header 350, comprises a motor isolation kit 200, and a header isolation kit 300. For purposes of this patent, the header 350 refers to where the drive track is mounted to the garage door wall.

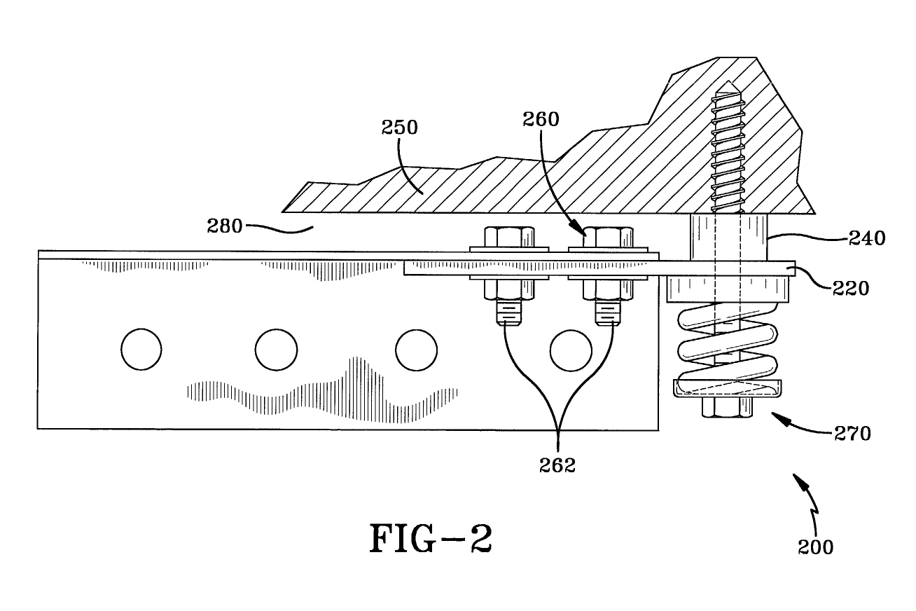

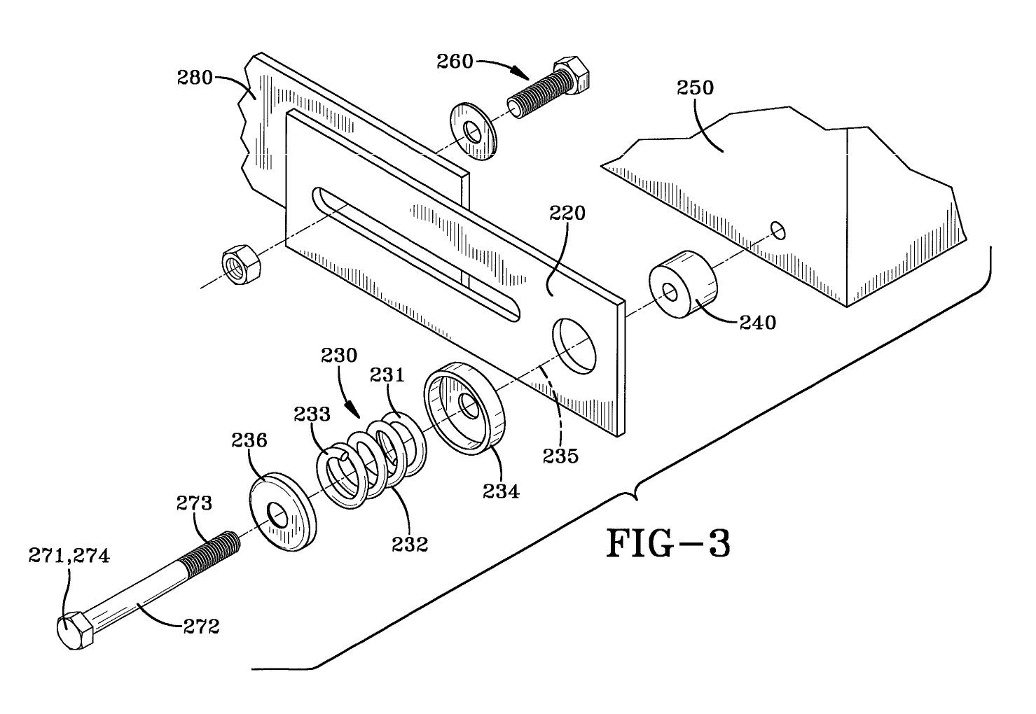

Referring now to FIGS. 2 and 3, according to another aspect of the invention, the motor isolation kit 200 comprises a motor mount plate 220, a motor vibration isolator 230, a motor vibration damper 240, a means 260 for mounting the garage door motor 210 to the motor mount plate 220 and, a means 270 for mounting the motor mount plate 220 to the ceiling 250 such that the motor mount plate 220 is isolated from the means 270 for mounting the motor mount plate 220 to the ceiling 250 by the motor vibration isolator 230, and, wherein the motor mount plate 220 is isolated from the ceiling 250 by the motor vibration damper 240. Any suitable means may be used for mounting the motor 210 to the motor mount plate 220 and the motor mount plate 220 to the ceiling 250. FIGS. 2 and 3 show combinations of nuts, bolts and washers as a suitable means, but this is not intended in any way to limit the scope of the invention to such mounting means.

For clarity, FIGS. 2 and 3 show one motor mount plate 220, and the mounting means 260/270, motor vibration isolator 230 and motor vibration damper 240 associated therewith. To mount a motor to the ceiling may (and in most cases will) require more than one motor mount plate 220. If more than one motor mount plate 220 is required, each would come with the parts shown in FIGS. 2 and 3 and described herein, and as such would still be within the scope of the invention

In a preferred embodiment of the invention, the motor vibration damper 240 is an elastomeric pad, in a best mode this elastomeric pad is specifically a closed cell foam material. In a further preferred embodiment, the motor vibration damper 240 is an elastomeric pad which is simultaneously in contact with the motor mount plate 220, and the ceiling 250. When the motor vibration damper 240 is in this configuration it causes a gap 280 between the ceiling 250 and the motor mount plate 220 equal to the compressed thickness of the elastomeric pad. In a preferred embodiment, the elastomeric pad is of a sufficient thickness such that when installed, the gap 280 is a minimum of 0.75 inches. In a further preferred embodiment, the elastomeric pad is of a sufficient thickness such that when installed, the gap 280 is a minimum of 0.5 inches.

According to an aspect of the invention the motor vibration isolator 230 comprises a spring 232 having an end one 231 and an end two 233. The vibration isolator may further comprise a spring cup 234, wherein the spring cup 234 is of an elastomeric material and wherein the spring cup 234 covers end one 231 of the spring 232.

In a preferred embodiment, the means 270 for mounting the motor mount plate 220 to the ceiling 250 comprises lag bolts 272 each having opposing ends, end three 271 and end four 273 wherein end three 271 is a bolt head 274 and end four 273 is threaded.

In a further preferred embodiment, the motor vibration isolator 230 further comprises a spring load cap 236. The spring 232 has a longitudinal center axis 235, wherein there is a spring 232 and a spring cup 234 for each lag bolt 272 used, and wherein the lag bolts 272 pass through the spring 232 along the longitudinal center axis 235, and wherein the spring end two 233 rests on the spring load cap 236, and the spring load cap 236 rests on the bolt head 274, such that the lag bolts 272 do not come in contact with the spring 232 or the motor mount plate 220, and wherein the motor mount plate 220 rests on the spring cup 234.

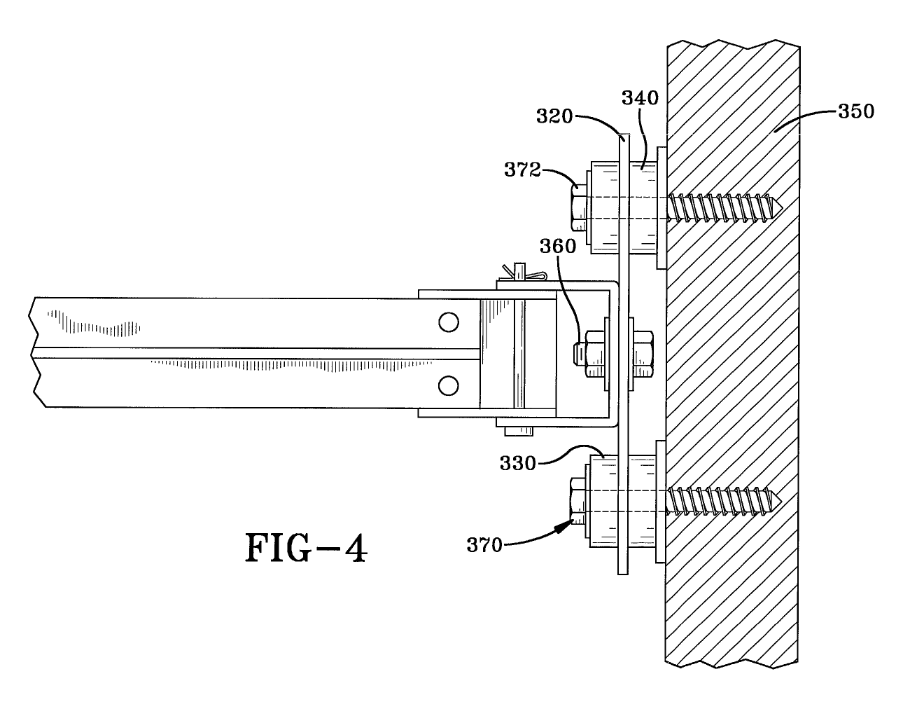

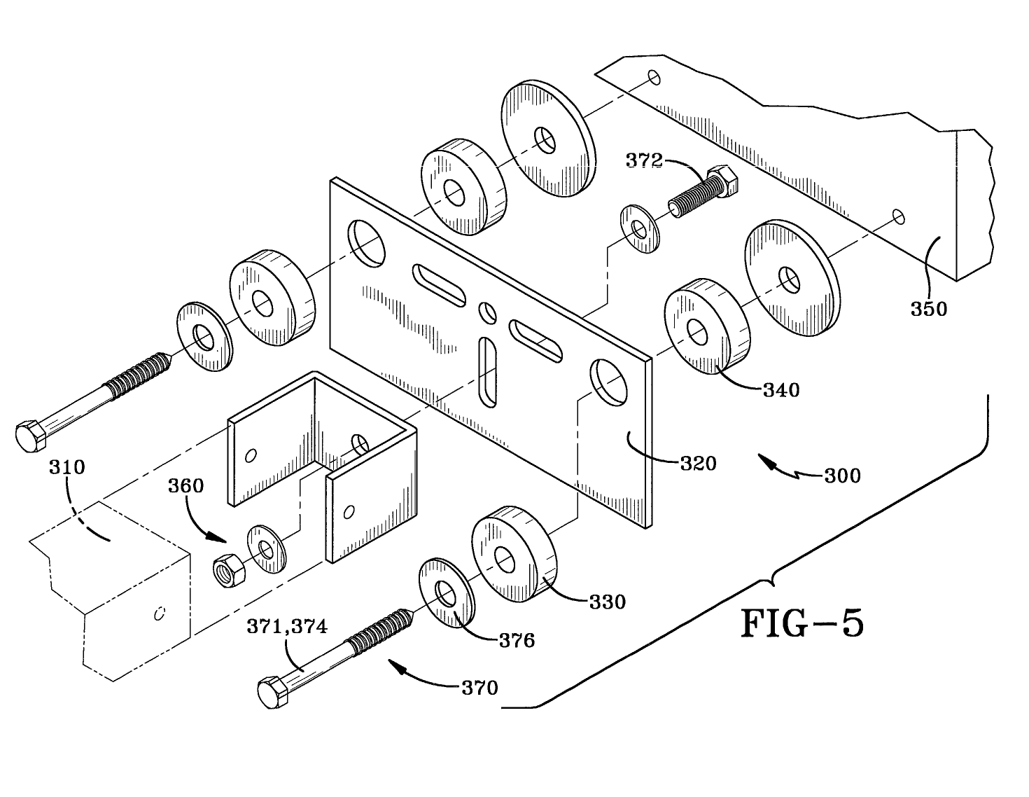

Referring now to FIGS. 4 and 5, according to a further aspect of the invention, the header isolation kit 300 comprises a header mount plate 320, a outer header vibration isolator 330, a inner header vibration isolator 340, a means 360 for mounting the drive track 310 to the header mount plate 320, a means 370 for mounting the header mount plate 320 to the header 350 such that the header mount plate 320 is isolated from the means 370 for mounting the header mount plate 320 to the header 350 by the outer header vibration isolator 330, and, wherein the header mount plate 320 is isolated from the header 350 by the inner header vibration isolator 340. Any suitable means may be used for mounting the drive track 310 to the header mount plate 320 and the header mount plate 320 to the header 350. FIGS. 4 and 5 show combinations of nuts, bolts and washers as a suitable means, but this is not intended in any way to limit the scope of the invention to such mounting means.

FIGS. 4 and 5 show one header mount plate 320, and the mounting means 360/370, outer header vibration isolator 330 and inner header vibration isolator 340 associated therewith. To mount a drive track to the header may require more than one header mount plate 320. If more than one header mount plate 320 is required, each would come with the parts shown in FIGS. 4 and 5 and described herein and as such would still be within the scope of the invention.

In a preferred embodiment of the invention, the inner header vibration isolator 340 comprises an elastomeric pad. In a further preferred embodiment, the outer header vibration isolator 330 also comprises an elastomeric pad. In a best mode, these elastomeric pads are specifically a neoprene material.

According to an aspect of the invention, the means 370 for mounting the header mount plate 320 to the header 350 comprises lag bolts 372. The lag bolts 372 each have opposing ends, end three 371 and end four 373, wherein end three 371 is a bolt head 374 and end four 373 is threaded.

According to a further aspect of the invention, the inner header vibration isolator 340 is in simultaneous contact with the header mount plate 320 and the header 350, and wherein there is a outer header vibration isolator 330 for each lag bolt 372, and wherein each outer header vibration isolator 330 is in simultaneous contact with the header mount plate 320 and each bolt head 374.

The mounting means 370 may further comprise a flat washer 376 for each lag bolt 372, and wherein the inner header vibration isolator 340 is in simultaneous contact with the header mount plate 320 and the header 350, and the outer header vibration isolator 330 is in simultaneous contact with the header mount plate 320 and the flat washer 376, and wherein the flat washer 376 is in simultaneous contact with the outer header vibration isolator 330 and the bolt head 374. In a preferred embodiment, each inner header vibration isolator 340 has a center axis 342, and each lag bolt 372 passes through each inner header vibration isolator center axis 342.

We claim:

1. A garage door opener vibration isolation kit to isolate the garage door motor from the ceiling, and to isolate the drive track from the header, comprising: a motor isolation kit, and a header isolation kit.

2. The garage door opener vibration isolation kit of claim 1 wherein said motor isolation kit comprises:
a motor mount plate;
a motor vibration isolator;
a motor vibration damper;
a means for mounting said garage door motor to said motor mount plate and,
a means for mounting said motor mount plate to the ceiling such that said motor mount plate is isolated from said means for mounting said motor mount plate to the ceiling by said motor vibration isolator, and, wherein said motor mount plate is isolated from the ceiling by said motor vibration damper.

3. The garage door opener vibration isolation kit of claim 1 wherein said header isolation kit comprises:
a header mount plate;
an outer header vibration isolator;
an inner header vibration isolator;
a means for mounting the drive track to the header mount plate;
a means for mounting said header mount plate to the header such that said header mount plate is isolated from said means for mounting said header mount plate to the header by said outer header vibration isolator, and, wherein said header mount plate is isolated from the header by said inner header vibration isolator.

4. The garage door opener vibration isolation kit of claim 2 wherein said motor vibration damper comprises an elastomeric pad.

5. The garage door opener vibration isolation kit of claim 2 wherein said motor vibration damper comprises an elastomeric pad, and wherein said pad is simultaneously in contact with said motor mount plate, and the ceiling.

6. The garage door opener vibration isolation kit of claim 2 wherein said motor vibration damper comprises an elastomeric pad wherein said elastomeric pad is simultaneously in contact with said motor mount plate, and the ceiling, and wherein said elastomeric pad is of a sufficient thickness to keep said motor mount plate a minimum of 0.5 inches from the ceiling.

7. The garage door opener vibration isolation kit of claim 2 wherein said motor vibration damper comprises an elastomeric pad wherein said elastomeric pad is simultaneously in contact with said motor mount plate, and the ceiling, and wherein said elastomeric pad is of a sufficient thickness to keep said motor mount plate a minimum of 0.75 inches from the ceiling.

8. The garage door opener vibration isolation kit of claim 2 wherein said motor vibration damper comprises an elastomeric pad, specifically a neoprene material.

9. The garage door opener vibration isolation kit of claim 2 wherein said motor vibration isolator comprises a spring having an end one and an end two.

10. The garage door opener vibration isolation kit of claim 2 wherein said means for mounting said motor mount plate to the ceiling comprises lag bolts each having opposing ends, end three and end four wherein end three is a bolt head and end four is threaded.

11. The garage door opener vibration isolation kit of claim 2 wherein said motor vibration isolator comprises: a spring having an end one and an end two; and, a spring cup, wherein said spring cup is of an elastomeric material and wherein said spring cup covers end one of said spring, and wherein said means for mounting said motor mount plate to the ceiling comprises: lag bolts each having opposing ends, end three and end four, wherein end three is a bolt head and end four is threaded.

12. The garage door opener vibration isolation kit of claim 11 wherein said motor vibration isolator further comprises a spring load cap, and wherein said spring has a longitudinal center axis, wherein there is a spring and a spring cup for each lag bolt used, and wherein said lag bolts pass through said spring along said longitudinal center axis, and wherein said spring end two rests on said spring load cap, and said spring load cap rests on said bolt head, such that said lag bolts do not come in contact with said spring or said motor mount plate, and wherein said motor mount plate rests on said spring cup.

13. The garage door opener vibration isolation kit of claim 3 wherein said inner header vibration isolator comprises an elastomeric pad.

14. The garage door opener vibration isolation kit of claim 3 wherein said outer header vibration isolator comprises an elastomeric pad.

15. The garage door opener vibration isolation kit of claim 3 wherein said means for mounting said header mount plate to the header comprises lag bolts.

16. The garage door opener vibration isolation kit of claim 3 wherein said inner header vibration isolator comprises an elastomeric pad, specifically a neoprene material.

17. The garage door opener vibration isolation kit of claim 3 wherein said outer header vibration isolator comprises an elastomeric pad, specifically a neoprene material.

18. The garage door opener vibration isolation kit of claim 3 wherein said means for mounting said header mount plate to the header comprises lag bolts each having opposing ends, end three and end four, wherein end three is a bolt head and end four is threaded.

19. The garage door opener vibration isolation kit of claim 3 wherein said means for mounting said header mount plate to the header comprises lag bolts each having opposing ends, end three and end four, wherein end three is a bolt head and end four is threaded, and wherein said inner header vibration isolator comprises an elastomeric pad, and wherein said outer header vibration isolator comprises an elastomeric pad.

20. The garage door opener vibration isolation kit of claim 19 wherein said inner header vibration isolator is in simultaneous contact with said header mount plate, and said header, and wherein there is a said outer header vibration isolator for each said lag bolt, and wherein each said outer header vibration isolator is in simultaneous contact with said header mount plate and each said bolt head.

21. The garage door opener vibration isolation kit of claim 19 wherein said mounting means further comprises a flat washer for each said lag bolt, and wherein said inner header vibration isolator is in simultaneous contact with said header mount plate, and said header, and said outer header vibration isolator is in simultaneous contact with said header mount plate and said flat washer, and wherein said flat washer is in simultaneous contact with said outer header vibration isolator and said bolt head.

22. The garage door opener vibration isolation kit of claim 21 wherein there is a said inner header vibration isolator for each said lag bolt, wherein each said inner header vibration isolator has a center axis, and wherein each said lag bolt passes through each said inner header vibration isolator center axis.
